(19) United States
(12) Patent Application Publication
(10) Pub. No.: US 2013/0318135 A1
(43) Pub. Date: Nov. 28, 2013

(54) DATA RECORD DYNAMIC ACTIVE CONTENT SYSTEMS AND METHODS

(71) Applicant: Michael Nourani, Calabasas, CA (US)

(72) Inventor: Michael Nourani, Calabasas, CA (US)

(21) Appl. No.: 13/991,890

(22) PCT Filed: Dec. 5, 2011
(86) PCT No.: PCT/US11/63346

§ 371 Date: Aug. 8, 2013

Related U.S. Application Data
(60) Provisional application No. 61/420,191, filed on Dec. 6, 2010.

(51) Int. Cl. G06F 17/30

(52) U.S. Cl. CPC G06F 17/30203
USPC 707/827

(57) ABSTRACT

A record management system includes a record data store, on a server, configured to store a plurality of records for access by a host application on a remote device, each of the records having a plurality of data elements; and an applet data store configured to store a plurality of applets for execution by the host application. The system is configured to associate an applet of the plurality of applets with a record of the plurality of records based on a request from the host application. The associated applet is for processing at least some of the data elements of the record. The associated applet is for publishing at least some of the data elements of the record.

### CROSS-REFERENCE TO RELATED APPLICATIONS

This application claims priority to U.S. Provisional App. No. 61/420,191, filed Dec. 6, 2010, which is herein incorporated by reference in its entirety.

### FIELD OF THE DISCLOSURE

This disclosure generally relates to document management systems and methods, and, in particular, relate to data record dynamic active content systems and methods.

### BRIEF DESCRIPTION OF THE DRAWINGS

FIG. 1 is a block diagram of a hardware configuration implementing a document management system and/or method in accordance with an embodiment of the present invention;

FIG. 2 is a sample workflow in accordance with an embodiment of the present invention;

FIG. 3 illustrates a view of a record in accordance with an embodiment of the present invention;

FIG. 4 illustrates a view displayed when using a applet in accordance with an embodiment of the present invention; and

FIGS. 5A-5C illustrate exemplary data content for various types of data trackers in accordance with an embodiment of the present invention.

### DETAILED DESCRIPTION

Various embodiments include program products comprising computer-readable media for carrying or having computer-executable instructions or data structures stored thereon. Such computer-readable media can be any available media that can be accessed by a general purpose or special purpose computer or server. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. Combinations of the above are also to be included within the scope of computer-readable media. Computer-executable instructions comprise, for example, instructions and data that cause a general-purpose computer, special purpose computer, or special purpose processing device to perform a certain function or group of functions.

In addition to a system, various embodiments are described in the general context of methods and/or processes, which may be implemented in one embodiment by a program product including computer-executable instructions, such as program code, executed by computers in networked environments. The terms “method” and “process” may be synonymous unless otherwise noted. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers hand-held devices, multi-processor systems, microprocessor-based or programmable consumer electronics, network PCs, minicomputers, mainframe computers, and the like.

In some embodiments, the method(s) and/or system(s) discussed throughout may be operated in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices. In various embodiments, data may be stored either in repositories and synchronized with a central warehouse optimized for queries and/or for reporting, or stored centrally in a database (e.g., dual use database) and/or the like.

An exemplary system for implementing the method(s) discussed might include a general-purpose computing device in the form of a conventional computer, including a processing unit, a system memory, and a system bus that couples various system components including the system memory to the processing unit. The system memory may include read only memory (ROM) and random access memory (RAM). The computer may also include a storage medium, such as a solid state storage device and/or a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media may provide nonvolatile storage of computer-executable instructions, data structures, program modules, and other data for the computer.

Various embodiments employing software and/or Web implementations may be accomplished with standard programming techniques with rule-based logic and other logic to accomplish the various database searching steps, correlation steps, comparison steps and decision steps. In addition, the words “component” or “module,” as used herein, may encompass implementations using one or more lines of software code, hardware implementations, and/or equipment for receiving manual inputs.

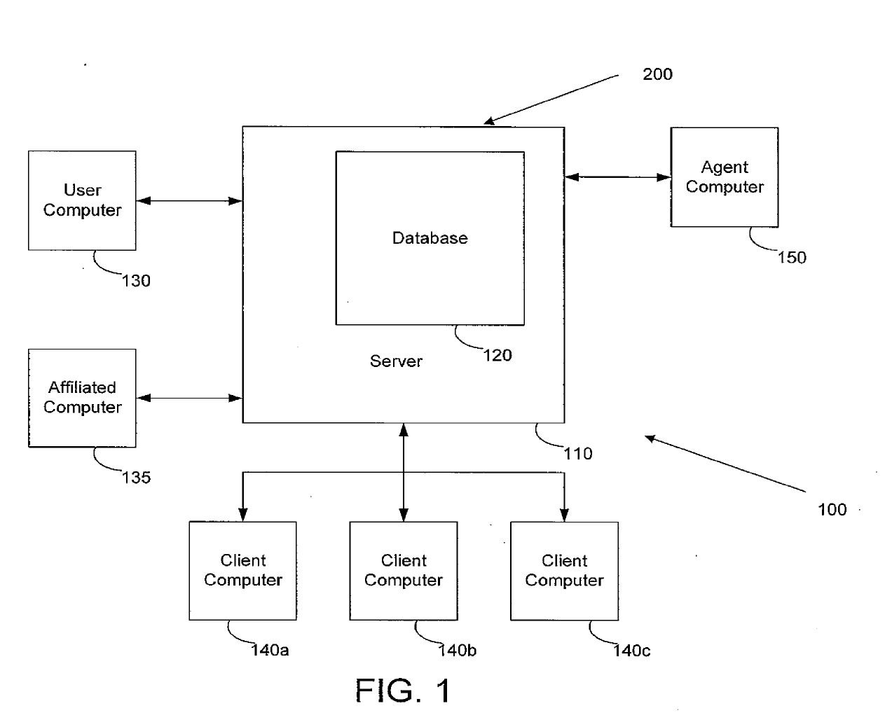

Embodiments of the present invention generally relate to document management systems and methods, and, in specific embodiments, to document management systems and methods implementing customizable application extensions. In various embodiments, a user may access such a system or method through a website, for example via subscriber computer (e.g., 130 in FIG. 1), or in any suitable manner. It should be noted that the terms “user,” “subscriber,” “user-subscriber” are used interchangeably in the disclosure, unless otherwise noted.

The website provides product information and description of each of a plurality of subscription plans. For instance, the website may offer three distinct subscription plans. Subscription plans may be based on varying criteria that may include (but is not limited to) number of affiliated users (i.e., users using the subscription plan), data storage (i.e., volume of information allocated for data storage), and/or any the like. Thus, in some embodiments, each of the subscription plans may vary based on a preconfigured number of affiliated users and volume of information allocated for user data storage.

In some embodiments, the subscription plans may be augmented as desired by the subscriber. For instance, the subscriber may increase the number of affiliated users and/or data storage, which increases the number of records that can be created and maintained by the subscriber. Thus, according to various embodiments, a subscriber can select a subscription plan and, at the time of signup or any time during the active subscription, purchase additional user counts, records and/or storage.

Once a subscription plan is selected, the subscriber may register for an application space during the signup session (or later session) by providing additional information, such as (but not limited to) a space name (e.g., medical practice name), billing information, and/or the like. In some embodiments, the billing information may include payment (e.g., credit card) information. The payment information may be used for (but not limited to) the initial subscription fee, monthly subscription fees, additional purchases to increase subscription plans, additional purchases to add or install features, additional purchases to add applets, in-applet purchases for additional features and application specific enhanced/advanced functionality, services controlled by installed applications independent of the subscription fees, and/or the like.

The website may provide a plurality of space templates from which the subscriber may select based on his or her needs. A space template may include a preconfigured model (or catalog) of records, attributes, applications, and features specifically designed for a given business type. Accordingly, the system populates (e.g., customizes) the space with data elements, forms, records items, and/or the like (as discussed below) based on the selected space template. In some embodiments, there may be more than one space template that can be selected for a given business type. For instance, for a medical application space, there may be space templates directed to solo practitioners, clinics, independent physician, and/or the like.

In various embodiments, the subscriber can, during the signup session (or later sessions), invite additional users to the space of the subscriber. For instance, an email invitation with temporary login credentials may be sent to invitees (e.g., affiliated users) to allow them to access the space created by the subscriber at a capacity or role decided by the subscriber. The role assigned to each affiliated user may be based on the available roles on the system for a given space. For instance, in a case of a medical application, roles may include provider, front-desk, nurse, biller, staff, and/or the like. Access to the system records and the ability of an affiliated user to add, edit, and/or remove records or documents is dictated by the role assigned to the affiliated user logged in the space.

FIG. 1 illustrates an exemplary hardware configuration (e.g., network environment) 100 employing a records management system 200. In various embodiments, the records management system 200 is configured to provide architecture to support active content (applets) as part of a stored record by a host application. The host application is an application, by following a defined protocol, enables active content (applet) functionality as an extension of the native functionality of the host application. The host application may be run on a client device (e.g., computer 130, 135, 140a-140c, 150). In some embodiments, the host application defines its own protocol for a closed system in which active content (applets) is developed internally, for example. In other embodiments, programmers may develop, script, design, and/or the like their own applets, which can be plugged into or otherwise implemented with the host application.

The system 200 may include one or more databases 120 hosted on one or more servers 110. One or more spaces (application spaces), records, and applets are contained in the one or more databases 120. The one or more spaces, records, and applets hosted on the one or more servers 110 may be accessed remotely by the host application being run on the client device. The hosted or local server hardware system 200 (or 110), which may include the one or more databases, may include information on configuration, directory structure, web application enablers, and/or the like.

The creation of the space creates an entity within the hosted or local server hardware system 200. According to various embodiments, the application space is the context that the host application sets up for the user. Throughout various embodiments, the entity may have components (e.g., records, applets, data, etc.) on one or more hardware units housed at a single or multiple physical and/or geographical locations. For example, some of the components may be located at a first server (e.g., server 110 in FIG. 1) and other components may be located at a second server (not shown). In some embodiments, at least some of the components may be owned by the service provider. In some embodiments, at least some of the components may be leased and/or rented equipment and/or collocated owned equipment on datacenters that are owned and operated by independent firms and providers.

The subscriber (e.g., a doctor), for example via subscriber computer 130, can create, modify, or otherwise access the spaces, records, and applets on the server 110. For instance, once configured with a selected template and optional components, the host application can be used by the subscriber to create, edit, and delete records representative of each defined type. In a case of a medical application, record types, may include (but are not limited to) providers, patients, labs, staff, insurance companies, referring physicians, and/or the like.

Affiliated users (e.g., doctor's staff), such as the invitees invited by the subscriber, can also create, modify, or otherwise access, for example via affiliated computer 135, the spaces, records, and applets based on respective assigned roles of the affiliated users. In various embodiments, agents or other third party, for example via remote computer 150, can modify some of the spaces, records, and applets, as described below. In some embodiments, other users, such as the subscriber's clients (e.g., patients), can access the space, for example via client computers 140a-140c. These other users can access the space, for instance, to allow access to their respective records (e.g., to see results, schedule an appointment, etc.) or other relevant data.

It should be noted that although many of the examples described in the disclosure relate to medical applications and the like, the system 200 may be tailored to any suitable field including, but not limited to, the legal field, commercial field, and/or the like.

Throughout various embodiments, the records management system 200 manages information, data, and the like. Information in the system 200 is based on records and content. In addition, as described later, the system 200 may be configured to manage (one or more of) documents, information transportability, scheduling, workflow relating to the records and/or content, and/or the like.

Records refer to entities in the system 200 about which information is stored, retrieved, reported, and generally managed. Records are defined as “item types.” In some embodiments, item types are defined in a space catalog for each space and can be edited and changed anytime during the lifetime of a space. Space templates contain a set of predefined item types, which may be introduced in the space catalog, for example, when the space is created. Additional item types may be added and removed without any adverse effect on the system 200 or a need for any special maintenance of the maintenance.

Each item type may contain information about the item type and a set of attributes or properties relating to the item type. It should be noted that the terms attributes and properties may be used interchangeably. Attributes may be defined individually and independently of the item type. Attributes may be added, removed, or otherwise modified, for example, at any time during the lifetime of a space and/or item type. Attribute types associated to an item type dictate and define the item type and format of information stored about an item of a given type. For instance, an example of an item type (for a record) may be “Patient,” and examples of attribute types for the “Patient”-item type may be “Name,” “Primary Insurance,” “Date of Birth,” and/or the like. Records may be introduced to a space using a type catalog. The type catalog may also include a catalog of property types defined for each item type.

According to some embodiments, attribute types may contain (but are not limited to) the following attributes: name; caption; type; storage format, textual, binary, or internal id formats; security settings; sequence; icon or image; control type; and/or the like.

The caption may be displayed in a form for the field. In various embodiments, the system 200 may be configured to translate the caption to different languages without affecting the internals of the system 200. The type may include (but is not limited to) numerical, text, date, yes/no, selection from a fixed list, selection from a list of other types (referred to as reference types), ordered list of selections when more than one selection is allowed from a fixed list or a reference list, and/or the like.

The security settings may dictate the viewing, editing, and publishing rights for each user category or user role. The system 200 may present the data entry form in a specific order based on the sequence. The icon/image may be an optional icon/image displayed next to the field.

The control type may enable selection of a specific input method, for example such as (but not limited to) calendar drop down list for dates, a numerical up-down list for numbers, intelligent selection when selecting from options made up of thousands of records, and/or the like. The control type can be a standard type, predefined type, or a custom data-entry method for specialized data entry, such as reading information from sources external to the application using the world wide web, and/or a hardware-assisted data-entry method from equipment (e.g., EKG, SNMP, and other programmatic interfaces to real world equipment). Examples of item types for which records are created may include (but is not limited to): “Patient,” “Provider” (e.g., doctor), “Staff,” “Lab,” “Equipment,” “Specimen,” etc.

Each item type has any number of attribute (or property) types. Examples of property types for the “Patient”-item type may include (but is not limited to) “Patient Name,” “Address,” “Phone Number,” etc. Each of these property types, for example, may comprise text (e.g., 50 characters or less) or the like entered into a corresponding field in the data entry form. Such text or the like may be entered, for example, by the subscriber-doctor, staff, patient (e.g., by logging into the doctor's space), etc.

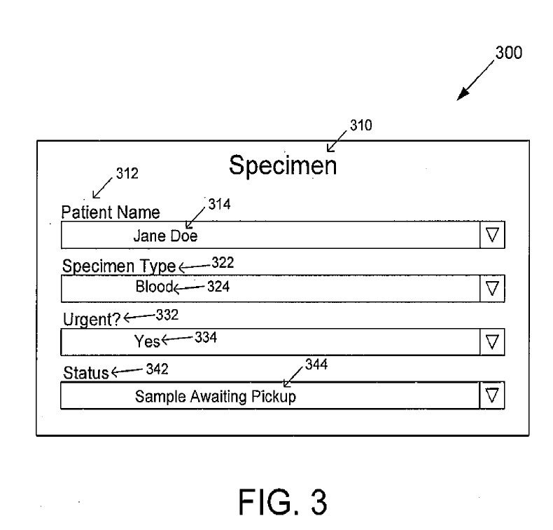

An example of a record for a patient may include the item type: “Patient,” and the attribute types (along with entered text): “Name” (“John Doe”), “Address” (“123 Smith St. Los Angeles, Calif., 90017”), “Phone Number” (“213-555-1234”), etc. An example of a record 300 of a patient's blood sample is shown in FIG. 3. In this example, an item type 310 of the record 300 is “Specimen,” and the attribute types (along with entered text) are: “Patient Name” 312 (“Jane Doe” 314), “Specimen Type” 322 (“Blood” 324), “Urgent” 332 (“Yes” 331), “Status” 342 (“Sample Awaiting Pickup” 344).

With reference to FIGS. 1-3, in some embodiments, a data entry form is dynamically generated by the application to allow the subscriber or other users to add, edit, and remove records of a specific item type.

A record (e.g., 310) may include or otherwise be associated with a container, which may be synonymous with a file jacket or dossier. The container for each record may hold a multitude of information in a multitude of formats. From a user's perspective, there may be no distinction between the native format of the container content and the storage mechanism of the container content.

In general, the container content may comprise one or more of files on disk (e.g., on the server 110), records in the database 120, and records in other databases and/or storage systems. Files on disk may include electronic files and documents stored in computer storage media and associated with the record. The files may be stored at any suitable location such as the server 110, the database 120, other remote location, and/or the like. In some embodiments, the files may by stored locally. In some embodiments, the files may be stored in a private area amongst other files associated with the same record. Records in the database 120 may be traditional records in a database such that a row of information with fixed or dynamically assigned field names and types are associated with the owning record based on a unique ID. Records in other databases and storage systems may be records grouped together due to their content or accessibility requirements. In such cases, information can be stored amongst other database records associated with different owners.

Although the above description internal to the system 200 is virtually all encompassing, from the user's perspective, record content is created and viewed as any of the following categories: documents uploaded from a disk or media; media files; scanned documents; applets; data recordings; and/or the like. Media files may include (but are not limited to) images, audio and/or video uploaded directly from their original source (e.g., camera, voice recorder, etc.) or other source. Scanned documents may include, for example, physical documents converted to digital format for upload and transmission to the system 200 (e.g., the server 110). Applets are specific-purpose applications that provide a plurality of functionality as explained in detail below. Data recordings may include data associated with applets. For instance, a applet may be configured to record, create, or deduce information that can be uploaded and stored as an information unit associated with an owner record.

In various embodiments, a record may contain information fields (data points) directly as part of the definition of the record, and indirectly, for instance, when the user or the system 200 attaches applets (discussed later), documents, or the like. Data points refer to any piece of information stored within the system 200 associated with a record. Some examples include zip code, date of birth, credit card balance, or the like. Data point summaries are aggregate information about data points selected based on a type of optional criteria, such as a number of transactions, count of visits, total (sum of) duration of visits, or the like.

In various embodiments, the system 200 may be configured to perform data tracking using “trackers” attached to data points. A tracker may act and monitor on any data point regardless of type of information represented in the data point. The tracker may be configured to store information for a configurable time interval or time period. For example, hourly trackers may track information for a given hour, then the resulting information is stored and all tracking information reset. Then tracking resumes for the data point with the current value as the starting point.

According to various embodiments, the tracker is configured to access to the associated data point (or value thereof) at arbitrary times, replicate the data to be stored as part of an internal storage of the tracker, represent the data in textual format regardless of its original content (e.g., date, text, numerical value of any precision, etc.), and/or the like.

In some embodiments, the tracker may be configured to monitor, record, and/or act upon an anonymous data point without any additional information regarding the use, purpose, and/or source of the data point. In some embodiments, multiple trackers can track the same data point. In further embodiments, each of the trackers may be configured to track a different period. For example, status (a data point) of a piece of equipment can be tracked by an hourly tracker and a shift (8 hour) tracker.

The system 200 may implement various tracker types some of which are described (but are not limited to) as follows.

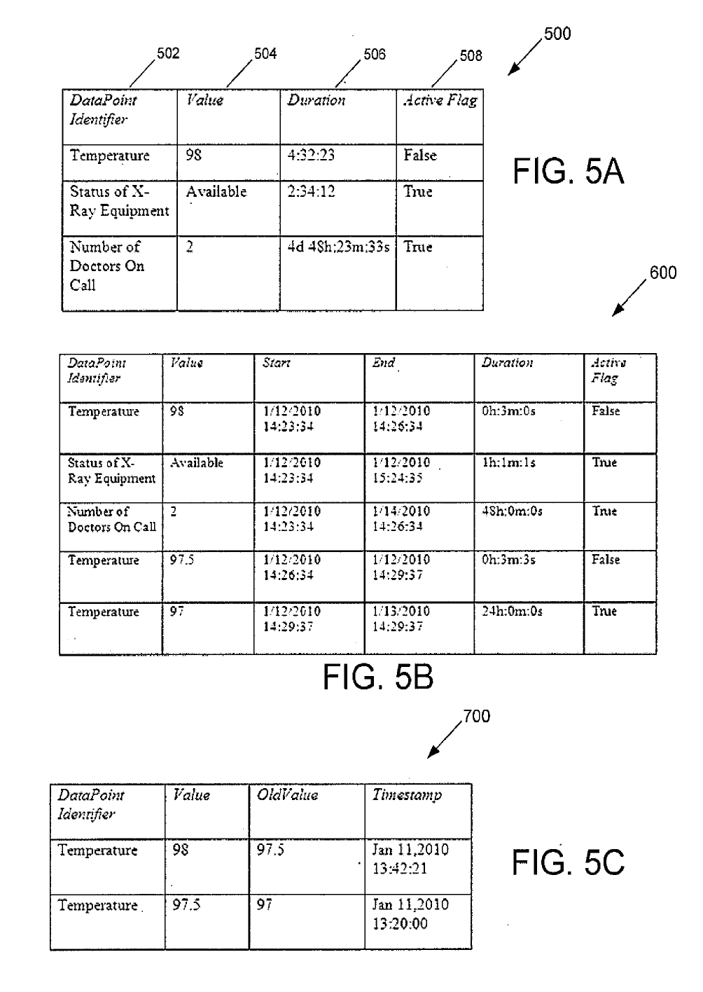

In some embodiments, a value tracker monitors a value of a data point and accumulates a duration of time the data point value was of a certain value. An example of resulting tracker content 500 from a value tracker from tracking temperature and time is shown in FIG. 5A. The tracker content 500 may include (but is not limited to) a data point identifier 502, a value 504, a duration 506, and a flag 508. The value tracker obtains a value 504 of a data point (temperature) 502 at regular time intervals or upon a change notification from the data point. Then, the current active value, if any, is deactivated (i.e., a setting in which the value is inactive). At which point, a current time is compared with an activation time to provide the duration 506. The duration is added to a “duration of state” for that value. After this, a determination is made whether this value has been encountered previously. If yes, the value is marked as active (e.g., True) 508, and the start time is set to the current time. If no, a new value is added to the list of collected values, the value is marked as active, and the start time is set to the current time.

A multi-tracker acts like a value tracker, but in addition, a repeating value causes a new entry in the list and the start and end times of the values are recorded as part of the tracker information. An example of resulting tracker content 600 is shown in FIG. 5B.

A logger is a type of tracker that creates an entry in a log marking date and time, and a value. Generally, values are not recorded unless there is a change in value. An example of resulting tracker content 700 is shown in FIG. 5C.

A time logger is a tracker that stores a value of a data point periodically regardless of change. Resulting tracker content would be similar to the resulting tracker content for a logger.

In particular embodiments, the data tracking includes functionality to provide readily consumable data tables for graphing and charting and the like. In general, the type of a tracker lends itself to a simple one-step presentation on a graphical presentation of a certain type. Although no inherit limitation in display format exists and left to the application and usage, the following is a non-exclusive list of plotting and graphing representations of tracker data. A value tracker may be used to generate a pie chart displaying distribution of values within a total value. Value trackers can also be used to generate, for example, a graph or chart as a percentage display. A multi-tracker may be used to generate stacked bar graphs displaying distribution of value over time. A logger may be used to generate a line graph. A time logger may be used to generate a line graph, where data points are at known intervals.

With reference to FIG. 1, records (of any item type) created by the system 200 (e.g., via the host application) are capable of holding information in form of documents. A record, regardless of its type, may contain any number of documents. A document may be added to (attached to or associated with) a record in any suitable manner.

For instance, computer electronic documents may be uploaded and attached to the record. The source of this type of document can be a user's disk, an attached device with storage such as a digital camera with photos, a voice recorder with audio files, a USB thumb drive with content, or any other “user computer”-accessible electronic storage. In some embodiments, the system 200 can be configured to interface with a camera on the user computer (e.g., 130) or other computer to display live video from the camera and allow single shot/video segment recording for direct upload from the camera without any additional interaction or a need for the user to store the information in a file, prior to uploading the information to a record.

As another example, one or more physical pages may be scanned in user's chosen format (e.g., PDF, JPG, PNG, etc.). In a further example, the system 200 may be configured to receive documents that are transmitted to the system 200 as an email, note, and/or attachment. The documents may include instructions on how to locate the record to which the information is to be attached. One manner for providing adequate information to the application on the record destination of an incoming email may include using an email address. As discussed in the disclosure, in some embodiments, each record may include a specific serial number or address information for identifying the space, record, and/or applet. The record identifier, for instance, may be the “prefix” in an email address to identify the specific record. For example, 2F1@klipmedical.com identifies a space and 2F16009@klipmedical.com identifies a record and the space. Another manner for providing adequate information to the application on the record destination of an incoming email may include using a formatted email subject line. In such embodiments, the email subject line, if formatted in a preselected manner, may be used to identify the recipient record for the email message and attached documents.

Throughout various embodiments, all (or mostly all) information in the system 200 is transportable and addressable. Addressability may be achieved using a unique identifier assigned by the system 200 at creation time to each record, property, applet, document, and applet properties, etc. The unique identifier may be constant and address the specific data element indefinitely.

According to various embodiments, unique identifiers are hierarchical and pinpoint information from higher level to the lowest level. A highest or first addressable level is the space. Once a space is created a unique m alphanumeric value (e.g., 3) is assigned as the identifier. A second level is the record where an additional n alphanumeric (e.g., 4) value is created. A third level can pin point a property within the record or a applet associated with the record. A fourth level is the property within a applet. Additional or fewer levels may be implemented as desired.

For instance, a unique identifier of “SSSRRRRPPP” may address a space, record, and property/attribute, for example, as in “Wellness Clinic”/“John Doe”/“Date of Birth.” Or for instance, a unique identifier of “SSSRRRRCCCPPP” may address a space, record, applet, and property, for example, as in “WellnessClinic”/“John Doe”/“Vitals Applet”/“Blood Pressure.”

As discussed, information can be sent to a specified record container. For example, an email to SSSRRRR@klipmedical.com may provide information to the record of John Doe. In various embodiments, information can be sent to a space or general inbox thereof, for example, by sending to an email to SSS@klipmedical.com. That is, throughout various embodiments, emails need only contain sufficient information identifying the space. This is because all identifiers contain a parent identifier. For instance, for a given space having an identifier A, each record is identified as AA, AB, AC, etc. Thus, any destination—even for a nonexistent record in space A—contains sufficient information to be associated with a proper space and be store in an inbox or the like for further review and eventual assignment to a proper record. In other embodiments, the system 200 may be configured to receive SMS messages or the like that may implement such hierarchies.

In various embodiments, information within records can be queried. For instance, a query, such as srvcs.klipmedical.com\SSSRRRR, can be input in the system 200 where the information is presented in response to the system 200.

Thus, various embodiments allow for addressability that enables information to be read, created, and updated by remote and/or loosely couple systems.

Portability may enable transmission (which may also be referred to as transportation) and presentation of any addressable information to a multitude of targets in any suitable manner.

With respect to portability of information content, portability may be achieved by an engine that takes responsibility of creating a presentable piece of information based on a given unique identifier and selecting the manner of transportation to a target. Portability may be enabled at any level of the hierarchy (with the exception of honoring security and data volume limitations inherit in technology). Portability may be applicable to records, attributes, applets, documents, applet properties, and/or the like.

Depending on the identifier, the information to be transported is rendered internally by the system 200 as in records and their property contents. Alternatively, the information to be transported may be delegated to a applet to provide custom transportable information chosen best for the application by an author of the applet.

In some embodiments, if a record with an applet is transmitted to a second system component (relative to a first system component, such as the user computer 130 or the like), the functionality of the applet is transmitted to the second system as well. The applet is independent of the second system, but is dependent on the host application (also running on the second system) activating the data to support the applet.

Information may be transported in any suitable format. For instance, in some embodiments, information may be transported as a recorded instance at time of recording. For example, information may be transported as a “vitals” applet (discussed below) that is rendered as a presentable text in PDF and/or HTML format. As another example, information may be transported as a weather report when the applet is transmitted to a recipient.

In some embodiments, information may be transported as a read-only representation at time of viewing. For example, information may be transported as a vitals applet that is rendered as a presentable online viewing of a live document showing values as they stand in the applet when the information is being viewed. As another example, information may be transported as a weather report when the applet is being viewed by a recipient regardless of the values and presentation when it was transmitted.

In some embodiments, information may be transported via an editable “Live” applet or document, which may be edited and/or altered and in which changes are in turn presented back to the original source (record, property, applet, document, applet property) within the system 200.

With respect to portability based on target and/or audience, in some embodiments, information may be transmitted as an imprint of instance. For example, information may be transported as a vitals applet rendered as presentable text in PDF and HTML formats.

In some embodiments, information may be transmitted in an original editable format. For example, information may be transported as an approval form sent via email that allows the recipient to take action and edit (approve) the document causing an update to an associated applet or record. In various embodiments, live information can only be made available with the recipient's access to a live network connection capable of reaching interact servers responsible for rendering and optionally updating the element transmitted.

Throughout various embodiments, any suitable method for transporting information to the system 200 may be used including, but not limited to, via email, fax, SMS text, voice message, and/or the like. With respect to email, for example, an electronic presentation, based on a PDF/HTML created by the presentation layer in the system 200 based on intrinsic built-in function and/or with the assistance of the applet codes per design of the applet author, may be used to provide a meaningful textual/image/graph presentation to be read and used by the user. With respect to fax, for example, a paper presentation, based on a PDF/HTML created by the presentation layer in the system 200 based on intrinsic built-in function and/or with the assistance of the applet codes per design of the applet authors, may be used to provide a meaningful textual/image/graph presentation to be read and used by the user.

An SMS (text) message may include, for instance, data values presented as text within the message. In some embodiments, the SMS message may include a URL where the actual data is presented by a server once the network address (URL) is activated on the mobile phone or other suitable device. A voice message may include, for instance, textual information read to a phone call recipient via an automated text-to-speech subsystem or the like.

In some embodiments, limitations exist based on the nature of graphical information not being available verbally or a long patient history from not fitting within an SMS message character length limitation. However, the system 200, at minimum, is able to provide at least a visual rendition of any element in the system 200.

Throughout various embodiments, the system 200 may be configured to maintain a timeline list. In some embodiments, the timeline may include specific record identifiers. As such, every record in the system 200 has a virtual calendar. Each calendar or timeline entry may contain, for instance, a task and a resource. Each calendar or timeline entry may also contain, for example, additional resources and/or the like. In other embodiments, the timeline does not include specific record identifiers.

In particular embodiments, a record may be associated with a schedule. For example, a patient record for John Doe may include his next appointment. As another example, a record for an X-Ray machine may include all dates and/or times for which the X-Ray machine is booked. In further embodiments, schedules for various records can be used to determine availability among the records. For example, to schedule an X-Ray, an available slot (e.g., date and time) in Dr. Shapiro's schedule would have to coincide with an available slot for an X-Ray machine and with an available slot in an X-Ray technician's schedule.

In particular embodiments, a record may be associated with a timeline. For example, a record for a particular X-Ray machine may include all dates and/or times the X-Ray machine was used. The dates and/or times, for instance, may derive from or otherwise correspond to dates/times for which the X-Ray machine had previously been booked, as previously discussed.

In particular embodiments, a record may include a revision history or timeline of when the record was created and/or modified. As such, user data entry and/or interactions may translate to addition, editing, removal, or the like thereof.

Thus, according to various embodiments, in the context of making an appointment, for example, the system 200 may display a plurality of available timeslots for each resource (e.g., doctor, X-Ray Machine, X-Ray technician, etc.) needed to perform the appointment. Selection of one of the available slots, places an entry with each of the records (e.g., patient, doctor, X-Ray Machine, X-Ray technician, etc.) as a task in a respective timeline of the records.

Throughout various embodiments, a workflow can be added to or otherwise associated with a space as an add-on application or the like. The workflow manages an element through a series of steps to achieve completion of or otherwise process the element.

In some embodiments, the workflow includes definition of a process, ticket, template, and/or sufficient information to manage each. A process is a unit of work. The process may optionally include various statuses or stages, such as, a start status, active status, end status, and/or the like. A ticket is a task or work unit (e.g., a specimen sent to a lab), which moves through the workflow by applying each process within the associated template.

A template is list of logic and processes that a task or work unit follows until completion of the work unit is achieved. For example, a simple workflow may include a template having a single process, such as approving a document.

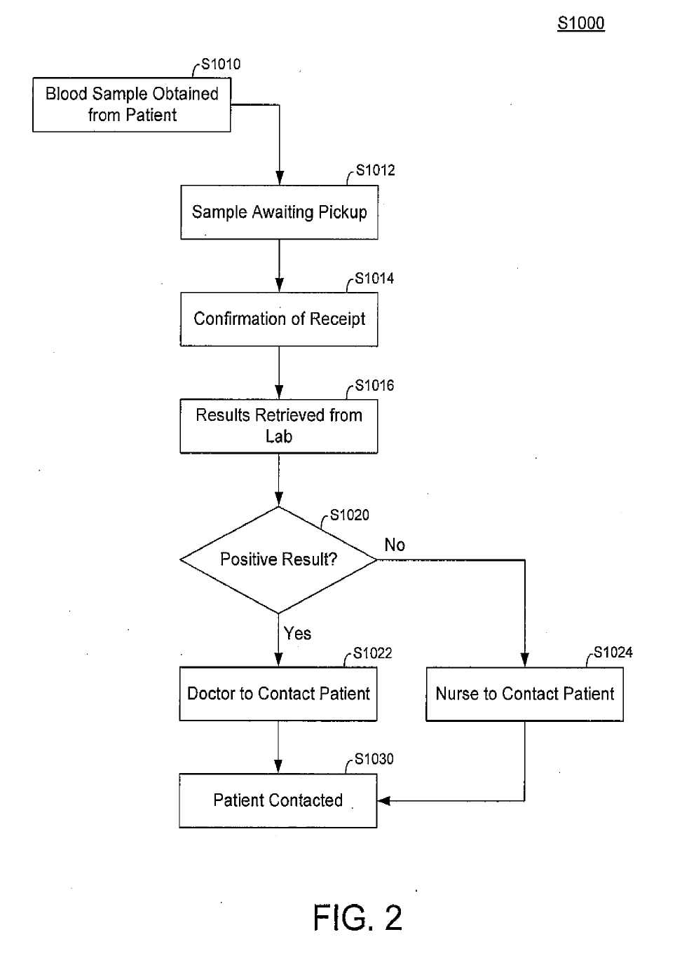

A more advanced workflow may include a template having a series of processes in sequence (and/or parallel). For example, a shipping workflow may include a template having processes to be performed in sequence. The sequence may include processes or steps indicating that (but not limited to any one or combination of), order created, order approved by manager, order sent to warehouse, pickup request sent to shipping company based on ticket information, and shipping company acknowledgment emailed to the email address of the record associated with the order. Another example is shown in FIG. 2, which illustrates an exemplary template (workflow) S1000 for processing a blood sample. For instance, after a blood sample is obtained (step S1010), the blood sample awaits pickup (step S1012), then confirmation of receipt from the lab is received (step S1014), then results are retrieved from the lab (step S1016), and then the patient is contacted (step S1030). In further embodiments, the results and/or the like can be updated in the patient's record and/or other suitable record.

A complex template is a template that may include conditional processes and decision blocks in addition to processes. For example, the template of the shipping workflow may include, for instance, conditional routing of tickets during off hours through a different list of processes. As another example, a template for a specimen workflow may be based on certain criteria, for instance, rush lab orders are sent to lab A, and all other lab orders are sent to lab B. Returning to the example shown in FIG. 2, if the result of the blood sample is positive (step S1020: Yes), the doctor is to contact the patient (step S1022). If the result of the blood sample is negative (step S1020: No), a nurse is to contact the patient (step S1024).

In further embodiments, the system 200 may be configured to update one or more records associated with the task as the task navigates through each step in the workflow. For example, in the example shown in FIG. 3, the status 342 of the specimen is “sample awaiting pickup 344.” The system 200 (refer to FIG. 1) updates the status, according to the example workflow of FIG. 2, upon confirmation of receipt of the sample by the lab.

With reference to FIG. 1, in various embodiments, the system 200 implements one or more applets that are executed in the context of the host application to extend the functionality of the host application. Applets are intelligent attachable elements with a programmed behavior. Applets can be attached to a record and can perform one or more specified functions.

Applets enable a directed, focused functionality layer that can be easily added to the host application or system without system-level infrastructure modification. Applets provide a higher-level functionality by inheriting the information base and functionality made available by the host application and the infrastructure of the system 200. In various embodiments, applets manipulate information (e.g., data elements) associated with records with accessibility to storage and services of the system 200. Applets may have access to other data sources, such as (but not limited to) external private and public resources via the network, user-computer capabilities, and/or the like.

Applets may be configured to provide functionality independent of host application and/or system 200 designs purpose and scope. Applets may be configured to add and enhance features and functions of the host application based on user needs independent of host application release cycles. Applets may allow independent service providers to sell/make available their services. For example, a transcription service provider may design or be associated with a transcription applet (as discussed alter) that allows users of the applet to upload audio and have the provider transcribe the text for a fee. Applets can provide users (e.g., subscribers) the choice of mixing and matching features and functionality. Applets may also allow for creating solutions based on “best of breed” service providers without being locked into a pre-bundled/pre-determined feature set. Applets may allow independent applet developers, based on a business model (as described below), to make available features that blend in natively into a customer install base. Independent developers can also take advantage of a flexible infrastructure within the system 200 without concern for upgrades, installation, and publication of their solution.

Applets may comprise definition files and code files. A definition file may identify, for example (but not limited to), the applet's name, attributes, images, description, and general user information. The definition file may read from a space specific catalog store location. The definition file is populated based on configuration of the space. A code file may be dynamically loaded at run time and “injected” into the host application to allow the host application to create instances of the applet.

The applets may be configured to comply with a basic interface to enable communication with the system 200. The applets may be configured to use a set of function/service calls to obtain information available from the system 200. The applets may be dynamically loaded and used, and may be purged and reloaded multiple times during a session.

Throughout various embodiments, applets may be configured to access: (i) a data store of the system 200 (e.g., catalog of types, records, other applets); (ii) their own respective data store, which may be designed, created, and maintained independently of the system 200 and unbeknownst to the system 200; (iii) internal server hardware and components thereof; (iv) internal and external data sources; and/or the like. In some embodiments, applets may be configured to refer to (i.e., consume from) information from the owning record and/or sibling applets (e.g., applets attached to the same record). In some embodiments, applets may be assigned private storage, which can be used by the applet to store documents, files, images, or any other computer storable information. Applets may be designed or otherwise configured to use the private storage in any form as the designer (developer) of the applet desires. Throughout various embodiments, applet functions may not require and/or may never user a private storage assigned to each by the system 200.

In various embodiments, applets may be configured to be aware of the owning record (i.e., the record with which the applet has been associated) and, optionally, any associated context (e.g., whether the applet was associated with the owning record by the subscriber-user specifically; a reason for associating the applet with the owning record; etc.).

In various embodiments, applets may contain functionality that is activated when viewed/active on the display screen of the client device (e.g., 130, 135, 140a-140c, 150) of a user (e.g., the subscriber, the affiliated user, etc.). In some embodiments, applets may have functionality even when not active on the screen. For example, a applet may be configured to provide a notification for an event email prior to an event. The applet may perform such functionality even if no user is actively viewing the applet or even when no user is logged in to a space.

In various embodiments, applets may be configured to publish information in the form of properties in a manner similar to attribute types of item types defined in the space catalog of types. This may allow, for instance, a specified audience to view a portion of a record (e.g., item type, applet, or the like). For example, a patient can receive a applet that allows the patient to log into his or her doctor's space to see his or her lab results. As another example, a referring physician can access information on a referred patient.

In some embodiments, published properties may include calculated fields. For example, a published property could be “age” as a numerical value based on the owning record's date of birth. As another example, a published property could be distance to a record's address based on the time the applet was added to the record and the distance calculated. As a further example, a published property could include the record's time zone.

In some embodiments, published properties may be include dynamically calculated fields based on external information sources. For example, a published property for an estimated driving time may be based, at least, on current traffic conditions as published by external web services or published information. As another example, a published property may be a patient's “ready for surgery” flag that may be based on lab results having been received and checked by the physician, in addition to insurance approval code having been stored in the owning records predetermined data field.

In various embodiments, published fields (properties) can participate in queries and conditional lists, much the same way as static attribute types of item types. One exemplary query is “List or female patients (SEX=F) vs. List of patients within 20 miles (APPLET:map.distance<=20).” Another exemplary query is “List of patient insured with ABC (INSURANCE=ABC) vs. list of patient with current balance due greater than $100 (APPLET:billing.balance>100).”

In some embodiments, published data can be scrubbed (e.g., with an anonimizer or the like) or otherwise stripped of information that identifies the record (e.g., patient). For example, such data can be used by universities or the like to compile data for research, surveys, or the like.

Throughout various embodiments applets may be designed or otherwise configured to include one or more suitable functionalities. It should be noted that the applet functionalities (and examples of such) described in the disclosure are merely exemplary. A applet may include any number (or none) of the functionalities described in the disclosure, as well as functionalities, not described in the disclosure.

In various embodiments, applets may include functionality as a data store. For example, a applet may be a patient history form to be associated with a record. The patient history form applet may be displayed on a display screen of the client device (e.g., the subscriber computer 130, the affiliate computer 135, the client computer(s) 140a-140c, the agent computer 150, etc.), faxed, enabled for remote viewing and data entry by a patient in the waiting room, and/or the like. As another example, a applet may be a user-designed form having extensive design capabilities that enable a user (e.g., subscriber) to customize forms based on his or her needs. In particular embodiments, the design can be used by the applet to gather and store information, for instance. As a further example, a applet may be designed or otherwise configured as a notepad. That is, the applet allows free form notes to be typed. In some examples, the applet may include optional features (which, for example, can be enabled for a free) to allow verbal dictation to the microphone attached to the computer upon which the applet instance is implemented. In further examples, recorded audio maybe stored in the applet as audio, which can be played back by the same applet, and/or as text based on functionality of a text-to-speech algorithm provided in the applet.

In various embodiments, applets may include functionality for aggregating other record/applet content. For example, storage used by a record based on all documents, applets, and other attachments related to the record. For example, a applet may be configured to provide a total of all payments made by aggregating payments from multiple “payment” applets in the owning record.

According to some embodiments, applets may include functionality for correlating information in the owning (associated) record with information from an external source. Non-limiting examples of information from an external source may include: median prices of houses in the record address; patient risk factors based on patient age, race, etc.; temperatures for cities and areas recorded in a “vacation destination requests” applet(s) associated with the same record; and/or the like. Another example of information from an external source may include government warnings and bulletins regarding drugs recorded in the prescription applet of the owning record. In this example, the applet may be designed or otherwise configured to refer to official government health websites and/or data stores accessible to public or based on a fee subscription.

In various embodiments, applets may include functionality for correlating information from other records of same and/or different type given any optional criteria. For example, a applet may configured to provide a graph or other visual indication of the owning record's income as compared to other records of the same type (e.g., to determine clients for investment firm space). As another example, a applet may be configured to display a number of visits for this patient (e.g., the owning record) compared to visits from other patients (e.g., other records) for the same provider/physician.

In various embodiments, applets may include functionality for providing an external service through the service provider or a third party. These services may be, for example, per-use, subscription, and/or membership based. For instance, in the context of a “Christmas card” applet, once the applet is added to a record, the applet may send an electronic posting to a mail house (or other suitable third party) at a predetermined time before Christmas with the name and address of the person corresponding to the record. As such, an order may be placed for a applet to be generated, based on a selected design and message, and promptly mailed to the person corresponding to the record.

As another example, a applet may provide a transcription service, for which an audio recording may be added to the applet, the audio may be posted to a transcription service provider (or other suitable third party) that transcribes the audio independently of the applet and the system 200 (and/or host application), and the transcribed text is returned and included in the same applet. As a further example, a homework assignment applet that allows an instructor to post an assignment may also include functionality for receiving, as an attachment, a completed assignment (along with sender identification) from a student. Accordingly, the completed assignment can be corrected, graded, or otherwise processed (by the instructor or other third party), whereupon a processed document (e.g., a PDF of a document showing corrections) is sent back to the student and/or the instructor. The applet may contain, for instance, the original documents (e.g., the assignment, the completed assignment as done by the student, the corrected assignment, etc.), information about date of assignment posting, and/or the like. As a yet further example, a applet may be configured such that given a property address, information, such as public records, sale pricing, ownership history, and/or the like, may be researched by a third party and returned for a fee.

In various embodiments, applets may utilize client system facilities to obtain/collect information and record the information as part of the applet data. In some embodiments, this functionality is available when the applet is active and displayed on the screen for a user (e.g., the subscriber, the affiliated user, etc.) on the client device, for example, the affiliated computer 135. For instance, a applet may be or may include an EKG reader enabler. Such a applet, for example, may contain logic to interface to an EKG machine, collect data, and store data as part of the applet data. This applet may rely on the interface hardware of the EKG installed on the client device (e.g., 130), on which the instance of the applet is running, at the time the applet is activated on the screen, although the source of the applet is still the application (space) hosted on a server (e.g., the server 110). Thus, in various embodiments, the system 200 makes no distinction between a first applet (e.g., an EKG recording applet) and a second applet (e.g., a notepad applet).

As another example, an image processing applet may be designed or otherwise configured to load files from a camera attached to the client device (on which the host application and/or the instance of the applet is running), compress images with color correction based on user settings, and store the images as part of the applet data. As a further example, a applet may be designed or otherwise configured to print a bar-coded address label with tracking information obtained from a shipping company, await user confirmation, issue a pickup request, continue monitoring the tracking information, and posting a notification message that the shipment has reached its final destination.

In various embodiments, applets may utilize external system facilities to obtain/collect information and record the information as part of the applet data. In some embodiments, this functionality may be available independent of the status of the applet (i.e., whether or not an instance of the host application and/or the applet is running on the client device). Portions of an application that are active independent of the status of the applet (e.g., whether active on a screen or dormant) are referred to as agents. Agents are responsible for specific functionality and can provide updates and notifications to the system 200. For instance, a applet may be designed or otherwise configured to register with a service and activate a functionality by which a applet property is updated with information from an external source without the applet being active. These services may be, for example, generic services where notifications are email based. In various embodiments, the author of the applet will have this service provided by an active component of the applet that is aware of the applet's design and functionality to enable the applet to perform its function.

As another example, a stock monitoring applet may be designed or otherwise configured to issue a warning or perform a certain action (e.g., buy or sell) when a price of a stock reaches a certain value. As a further example, a applet may be designed or otherwise configured to add itself to a list of awaiting lab results by a certain identification number to a service. Once the automated service receives the lab result, the value of “Received” in the applet changes to TRUE or YES. For instance, in the example shown in FIGS. 2 and 3, the status field 342 may be updated to “Sample Awaiting Pickup” 344 upon a blood sample being obtained from a patient.

In various embodiments, a applet may include data and a program for viewing, modifying, or otherwise accessing the data. Thus, both the data and the program can be attached to a record. For example, a applet may be sent to a patient that includes a PDF file (data) and Adobe Reader (program) or other suitable PDF viewer for viewing the PDF file.

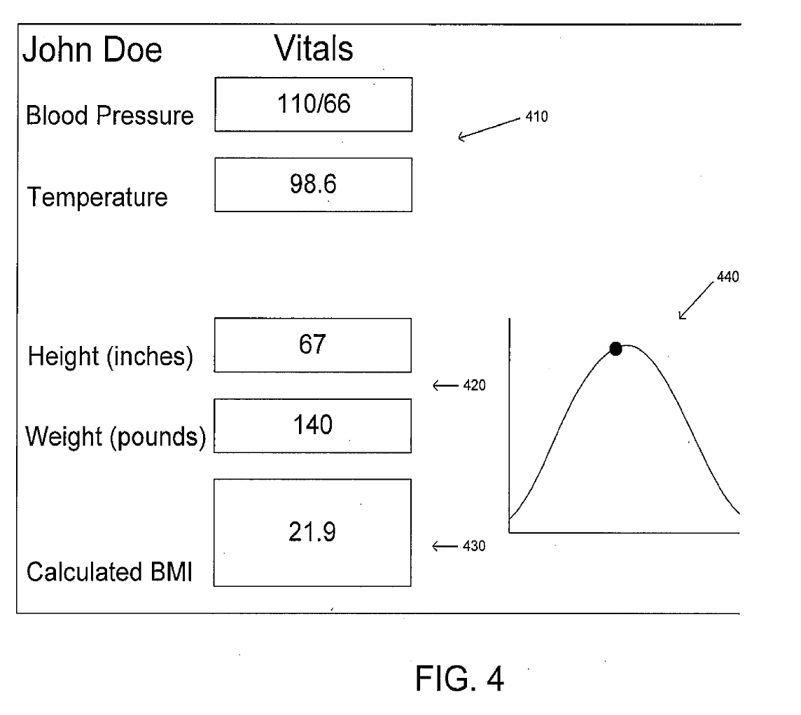

FIG. 4 illustrates an example of a applet known as a “Vitals” applet 400. The Vitals applet 400 can be added to a patient's record, like any other document, as described in the disclosure.

In some embodiments, the Vitals applet 400 may be configured such that at least some data (first data) 410 (e.g., blood pressure, temperature, height, weight, etc.) may be input directly into the applet. In some embodiments, the Vitals applet 400 may be configured such that at least some data (second data) 420 (e.g., age, sex, etc.) may be obtained from the patient's record (or other record), other applets, etc. In further embodiments, the Vitals applet 400 may be configured to determine or otherwise to know in advance (e.g., designed to include routing information) where relevant fields for obtaining information are located in each record or other location.

In some embodiments, the Vitals applet 400 may be configured such that at least some data (third data) 430 (e.g., BMI, risk of a heart attack, etc.) may be calculated based on the input data 410 and/or obtained data 420. In further embodiments, the calculated data 430 may be used to update data in the patient's record (or other record), other applets, etc. In further embodiments, the calculated data 430 may be published for viewing and or use by another program, application, entity, and/or the like.

In various embodiments, the Vitals applet 400 may configured to display graphical data 440, such as a BMI curve, map of record location (e.g., as discussed with respect to a Maps applet described later), and/or the like, on the display screen on which an instance of the Vitals applet 400 is running. In various embodiments, the Vitals applet 400 may be configured to display trend data, for example, in a list or graphical format. For instance, the Vitals applet 400 may display BMI values over time based on previous recordings of the Vital applets 400 recorded individually and associated with the record.

In various embodiments, the Vitals applet 400 may include a dictionary or the like that lists one or more properties in containers and can be used by other components (e.g., other applets, records, etc.) of the system 200. For example, the dictionary may include “BloodPressure” and its corresponding value is added to the list of information available on the record, resulting in a meaningful value for “JohnDoe.BloodPressure.”

Another example of a applet is a “Maps” applet that may be configured or designed to provide a location of a record or other associated item type. In various embodiments, the Maps applet may be configured to provide (or publish) longitude and latitude information, GPS coordinates, or other location-identifying information. In some embodiments, the Maps applet may be configured to estimate driving times to each record. For instance, the Maps applet may pushing an estimated driving time property based on the location-identifying information (e.g., longitude and latitude) of the record and current traffic conditions as published by external web services or published information. In further embodiments, the estimated driving times can be sorted, selected, or otherwise organized.

A further example of a applet is a “Fax Inbox” applet that may be configured to automatically attach a document, faxed to a particular number, to a specified record. The applet (or another applet) may include similar functionality in the context of emails, SMS/text messages, tweets on Twitter, status updates on Facebook, etc.

With reference to FIGS. 1-5(c), in various embodiments, the system 200 may be configured to transmit data and/or information from a applet and/or a record (or portions thereof). In some embodiments, the system 200 may be configured to transmit a applet or a record (or portions thereof) to an individual in any suitable manner including (but not limited to) email, fax, SMS, etc. In other embodiments, the system 200 may be configured to transmit access to a applet or a record. For instance, a subscriber-user may send an address to a location where a document (record) can be obtained. For example, a doctor may send a patient via SMS a link to a webpage at which the patient can access his or her lab results. In further embodiments, the system 200 can transmit the applet, the record, information related to such, access to such, and/or the like in a secured manner including the use of (but not limited to) one-time use links, links having an expiration, password/login credentials, and/or the like.

In some embodiments, the system 200 may be configured to transmit data to a client device or other device capable of reading or interpreting such data for use (e.g., to configure, control, implement, etc.) by the client device. For example, information in a patient's record (e.g., age, weight, etc.) can be sent to an EKG machine to configure the EKG machine for use with the patient.

In various embodiments, the system 200 may be configured to receive data and/or information to a applet and/or a record. In some embodiments, the system 200 may be configured to receive, from an individual, data or information to a applet or a record in any suitable manner including (but not limited to) email, fax, SMS, etc. For example, a patient intake form can be scanned (e.g., by an assistant at the doctor's office, by the patient at the patient's home, etc.) as an image and attached to a record of the corresponding patient.

In some embodiments, the system 200 may be configured to receive data, from a client device or the like, data or information to a applet or a record. For example, the system 200 may receive results from an EKG machine and attach the results directly to the patient's record.

In various embodiments, the system 200 may be configured to collecting data or information outside of the application. For instance, addition of a applet to a record can cause a solicitation of information via email from the record owner, or any record referenced by the record (e.g., referring physician of a patient). For example, information collection may be in the form of a questionnaire (e.g., rating service experience). As another example, information collection may be in the form of a request for documentation (e.g., a request for prior medical records from a referring physician). As a further example, information collection may be in the form of an approval request for an expense report payment applet from the manager associated with the employee whose record to which the applet was added.
In various embodiments, items in a record, applet, and/or space may include address information (targeting data) or unique identifier as previously described. In particular embodiments, each item in a record may be addressed individually, for example as discussed in the disclosure. In some embodiments, hierarchy levels of the items may be reflected in the address. For example, an address of a blood pressure value may be “2F9600110022667.” In this example, a first portion (“2F9”) of the address corresponds to a user space (e.g., Dr. Shapiro). A second portion (“6001”) of the address corresponds to a patient record (e.g., John Doe). A third portion (“1002”) of the address corresponds to a applet (e.g., Vitals Applet, as previously described). A fourth portion (“2667”) of the address corresponds to a blood pressure value provided in the applet.

Continuing with the above example, any items associated with this user space will begin with the same first portion. Thus, for instance, a blood pressure value of Jane Doe (corresponding to “6002”) may be “2F9600210022667.” Similarly, any items associated with the patient record will include the same second portion. Thus, for instance, an age value (corresponding to “1129”) for John Joe may be “2F960011129.”

In further embodiments, the system 200 may be configured to send or otherwise provide access to selected portions of the space, record, and/or applet using the address information. For example, Dr. Shapiro can send (e.g., via SMS) to John Doe a link corresponding to “2F9600110022667” at which John Doe's blood pressure is accessible, and optionally to the exclusion of all other information.

In further embodiments, the system 200 may be configured to receive documents or data based on the address information, for instance as discussed in the disclosure. In particular embodiments, the system 200 may organize the received documents or data based on the address information. For example, John Doe can send an email to 2F96001@klipmedia.com. Once received, the system 200 may attach the email and/or an attachment in the email in John Doe's record for Dr. Shapiro. In some embodiments, the system 200 attaches the email to the record automatically. In other embodiments, the system 200 attaches the email to the record upon further action by the user or the like (e.g., an office assistant approves that the document should be attached in the record).

Continuing with the above example, John Doe can send an email to a general email address for Dr. Shapiro, such as 2F9@klipmedia.com. In some embodiments, the email may be received in a general inbox or other collecting area for Dr. Shapiro and wait for further processing. For instance, an office assistant can attach the email received in the general inbox and attach the email to John Doe's record (or other appropriate area) after determining that John Doc was the sender. In other embodiments, the system 200 may be configured to process emails received in the general inbox automatically based on conditions, logic, or the like. For instance, the system 200 may parse or otherwise analyze sender information (e.g., email address), information contained in the email and/or attachment (e.g., name or signature in the email or attachment, sender's use of his address (e.g., “2F96001” or “6001”) on the email subject line or body, etc.), or other identifying information to determine the identity of the sender. Accordingly, the system 200 attaches the email to the record of the identified sender. Or for instance, the system 200 may compare sender information (e.g., email address) with similar information in the space (e.g., all email addressed in the space) to determine the identity of the sender and then attach the email to the record of the sender accordingly.

In various embodiments, the system 200 may be include or otherwise be associated with hardware (e.g., server(s) and/or database(s), which may (but not necessarily) include the one or more servers 110 and/or the one or more databases 120, for supporting a “Applet Store.” The Applet Store may be an online store, such as a software-based online digital media store (e.g., similar to the Apple “iTunes Store” or the like), a digital distribution platform (e.g., similar to the Apple “App Store” or the like), or other suitable distribution point for selling and/or distributing applets. The online store allows users to browse and download applets developed and published for the system 200. The applets may be downloaded or installed directly to a target location (e.g., the user's space). As such, a applet is copied from a database of a server hosting the Applet Store to the database 120 hosted by the server 110. Instances of the applet can then be accessed from the database 120 hosted by the server 110 via the user computer 130 (or affiliated computer 135, client computers 140a-140c, agent computer 150, and/or the like).

In some embodiments, the applets may be downloaded onto a client device, such as a computer or mobile device (e.g., 130), and then installed to the target location. As such, a applet is copied from a database of a server hosting the Applet Store to the user computer 130 (or the like). The applet on the user computer 130 can then be copied to the database 120 hosted by the server 110. Instances of the applet can then be accessed from the database 120 hosted by the server 110.

Applets may be available free or at a cost. Some applets may be purchased from the Applet Store for an upfront fee. Some applets may require the user to pay a transaction fee or percentage for each use of the applet, for instance after downloading the applet free or at some cost. Some applets (downloaded for free or at some cost) may include a certain number of uses or use for a defined period (e.g., one month, one year, etc.) of the applet. Subsequent use of the applet after the certain number of uses or the defined period may require the user to purchase a further number of uses or further period for the applet. In some embodiments, such this further purchase can be done automatically, for instance when the number of uses or defined period is exhausted or the user attempts to use the applet after exhausting the number of uses or the period has ended. In other embodiments, the user will be required to purchase manually a further number of uses or further period, for instance, after being prompted to do so. Some applets (downloaded for free or at some cost) may offer “in-applet purchases” that if purchased would provide additional features/functionality to the applet.

In various embodiments, the applets and/or the spaces may include advertisements or other third-party information, and in particular embodiments, may include directed advertisements or third-party information. For example, when a patient is sent his or her blood pressure via SMS, the SMS message may include an advertisement for or a link to blood pressure medication. As another example, the website (e.g., the doctor's space) where the patient can obtain his or her blood pressure information may include an advertisement for blood pressure medication. As a further example, a physician can be presented (e.g., at his or her space) latest drug information based on the conditions of the patient being examined in the room at the time of examination.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

1. A record management system, the system comprising:
a record data store, on a server, configured to store a plurality of records for access by a host application on a remote device, each of the records having a plurality of data elements;
an applet data store configured to store a plurality of applets for execution by the host application;
wherein the system is configured to associate an applet of the plurality of applets with a record of the plurality of records based on a request from the host application, the associated applet for processing at least some of the data elements of the record, the associated applet for publishing at least some of the data elements of the record.

2. The system of claim 1, wherein the request from the host application comprises an applet selected by a user of the host application from among the plurality of host applications.

3. The system of claim 1, wherein at least some of the plurality of data elements in a record is received from the applet associated with the record.

4. The system of claim 1, wherein at least some of the plurality of data elements in a record is received from a user input from the remote device.

5. The system of claim 1, wherein at least two applets of the plurality of applets are associated with the record, the at least two applets comprising a first applet and a second applet.

6. The system of claim 5, wherein the first applet processes at least some data elements provided by the second applet.

7. The system of claim 1, wherein publishing at least some of the data elements of the record comprises causing the host application to display the at least some of the data elements of the record.

8. The system of claim 1, wherein at least some of the data elements processed by the applet is published by the applet.

9. The system of claim 1, wherein the system is configured to associate data with the record associated with the applet.

10. The system of claim 9, wherein the data comprises electronic documents.

11. The system of claim 9, wherein the system is configured to store the associated data with the record associated with the applet.

12. The system of claim 9, wherein the system is configured to store the associated data separate from the record associated with the applet.

13. The system of claim 9, wherein the applet is configured to associate the data with the record associated with the applet.

14. The system of claim 9, wherein the system is configured to store the associated data on the remote device.

15. The system of claim 1, wherein the applet comprises a program stored on a server remote from the record to which the applet is associated, the system configured to manage access to the program.

16. The system of claim 1, wherein the applet data store is provided on the server.

17. The system of claim 1, wherein the applet data store is provided on a server remote from the server of the record data store.

18. A method of manufacturing a record management system, the method comprising:
configuring a record data store, on a server, to store a plurality of records for access by a host application on a remote device, each of the records having a plurality of data elements;
configuring an applet data store to store a plurality of applets for execution by the host application;
configuring the system to associate an applet of the plurality of applets with a record of the plurality of records based on a request from the host application, the associated applet for processing at least some of the data elements of the record, the associated applet for publishing at least some of the data elements of the record.

19. A method of managing records, the method comprising:
storing a plurality of records on a server for access by a host application on a remote device, each of the records having a plurality of data elements;
storing a plurality of applets for execution by the host application;
associating an applet of the plurality of applets with a record of the plurality of records based on a request from the host application;
processing, with the applet, at least some of the data elements of the record; and
publishing, with the applet, at least some of the data elements of the record.
